(19) United States
(12) Patent Application Publication
(10) Pub. No.: US 2013/0276385 A1
(43) Pub. Date: Oct. 24, 2013

(54) INSULATING SYSTEM

(71) Applicant: ARTHUR PAUL WHITE, LAKELAND, FL (US)

(72) Inventor: ARTHUR PAUL WHITE, LAKELAND, FL (US)

(21) Appl. No.: 13/888,465

(22) Filed: May 7, 2013

Related U.S. Application Data
(63) Continuation-in-part of application No. 13/356,036, filed on Jan. 23, 2012.
Application No. 13/356,036 is a continuation-in-part of application No. 13/135,689, filed on Jul. 13, 2011.

(51) Int. Cl. E04B 1/76; B32B 5/18; F16L 59/02; F16L 59/08

(52) U.S. Cl. CPC E04B 1/7612; F16L 59/08; B32B 5/18; F16L 59/029
USPC 52/90.1; 52/483.1; 428/411.1; 428/58; 428/457; 428/136

(57) ABSTRACT

A plurality of thermally insulating panels is adapted to abate the transmission of heat through conduction. A plurality of reflective sheets is coupled to the thermally insulating panels. The sheets are adapted to abate the transmission of heat through radiation. An air space is provided in proximity to the insulating panels with means to create a flow of air through the space. In this manner the flow of air through the air space is adapted to abate the transmission of heat through convection.

### RELATED APPLICATION

The present application is a continuation-in-part of application Ser. No. 13/356,036 filed Jan. 23, 2012 which, in turn, is a continuation-in-part of application Ser. No. 13/135,689 filed Jul. 13, 2011, the subject matter of which is incorporated herein by reference.

### BACKGROUND OF THE INVENTION

### Field of the Invention

The present invention relates to an insulating system and more particularly pertains to reducing the heating of a building through radiation and conduction abatement, such abatement being done is a safe, convenient and economical manner.

### SUMMARY OF THE INVENTION

In view of the disadvantages inherent in the known types of insulation system now present in the prior art, the present invention provides an improved insulating system. As such, the general purpose of the present invention, which will be described subsequently in greater detail, is to provide a new and improved insulating system and method which has all the advantages of the prior art and none of the disadvantages.

To attain this, the present invention essentially comprises an insulating system. A plurality of thermally insulating panels is adapted to abate the transmission of heat through conduction. A plurality of reflective sheets is coupled to the thermally insulating panels. The sheets are adapted to abate the transmission of heat through radiation. An air space is provided in proximity to the insulating panels with means to create a flow of air through the space. In this manner the flow of air through the air space is adapted to abate the transmission of heat through convection.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved insulating system which has all of the advantages of the prior art insulation systems and none of the disadvantages.

It is another object of the present invention to provide a new and improved insulating system which may be easily and efficiently manufactured and marketed.

It is further object of the present invention to provide a new and improved insulating system which is of durable and reliable constructions.

An even further object of the present invention is to provide a new and improved insulating system which is susceptible of a low cost of manufacture with regard to both materials and labor, and which accordingly is then susceptible of low prices of sale to the consuming public, thereby making such insulating system economically available to the buying public.

Even still another object of the present invention is to provide an insulating system for reducing the heating of a building through radiation abatement and conduction abatement, such abatement being done is a safe, convenient and economical manner.

Lastly, it is an object of the present invention to provide a new and improved insulating system adapted to reduce the heating of a building through radiation and conduction abatement, such abatement being done is a safe, convenient and economical manner.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred and alternate embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a cross sectional view of a portion of a building with an insulation system constructed in accordance with the principles of the present invention.

FIGS. 2 and 3 are cross sectional views taken along Ines 2-2 and 3-3 of FIG. 1.

FIGS. 4 and 5 are cross sectional views similar to FIG. 3 but illustrating alternate embodiments of the invention.

FIG. 6 is a perspective illustration of the fanfold panels of the prior Figures.

FIG. 7 is an enlarged perspective illustration taken at Circle 7 of FIG. 6.

FIG. 8 is a side elevational view of the fanfold panels, prior to installation, of the prior Figures.

FIG. 9 is a side elevational view of a building with an insulation system constructed in accordance with an alternate embodiment of the present invention.

FIG. 10 is a bottom view of a portion of the system taken along line 10-10 of FIG. 9.

FIG. 11 is a cross sectional view taken across the roof and insulation system of FIG. 9.

FIG. 12 is an enlarged showing of a portion of the insulation assembly taken at Circle 12 of FIG. 11.

FIG. 13 is a cross sectional view similar to FIG. 11 but illustrating another embodiment of the invention.

FIG. 14 is an enlarged showing of a portion of the insulation assembly taken at Circle 14 of FIG. 13.

FIG. 15 is a cross sectional view similar to FIGS. 11 and 14 but illustrating a next embodiment of the invention.

FIG. 16 is an enlarged showing of a portion of the insulation assembly taken at Circle 16 of FIG. 15.

FIG. 17 is a cross sectional view similar to FIGS. 11 and 14 but illustrating yet another embodiment of the invention with Circle 14 showing an enlarged section thereof.

FIG. 18 is a cross section of an alternate embodiment utilizing a new roof over an old roof.

FIG. 19 is a cross sectional view similar to FIGS. 17 and 18 but illustrating yet another embodiment of the invention.

FIG. 20 is an enlarged showing of a portion of the insulation assembly taken at Circle 20 of FIG. 14.

FIG. 21 is a plan view of the system shown in FIGS. 19 and 20.

FIG. 22 is a perspective illustration of the final alternate embodiment of the invention featuring a wall application.

FIGS. 23 and 24 are cross sectional views taken along lines 23-23 and 24-24 of FIG. 22.

The same reference numerals refer to the same parts throughout the various Figures.

### DESCRIPTION OF THE PREFERRED EMBODIMENT

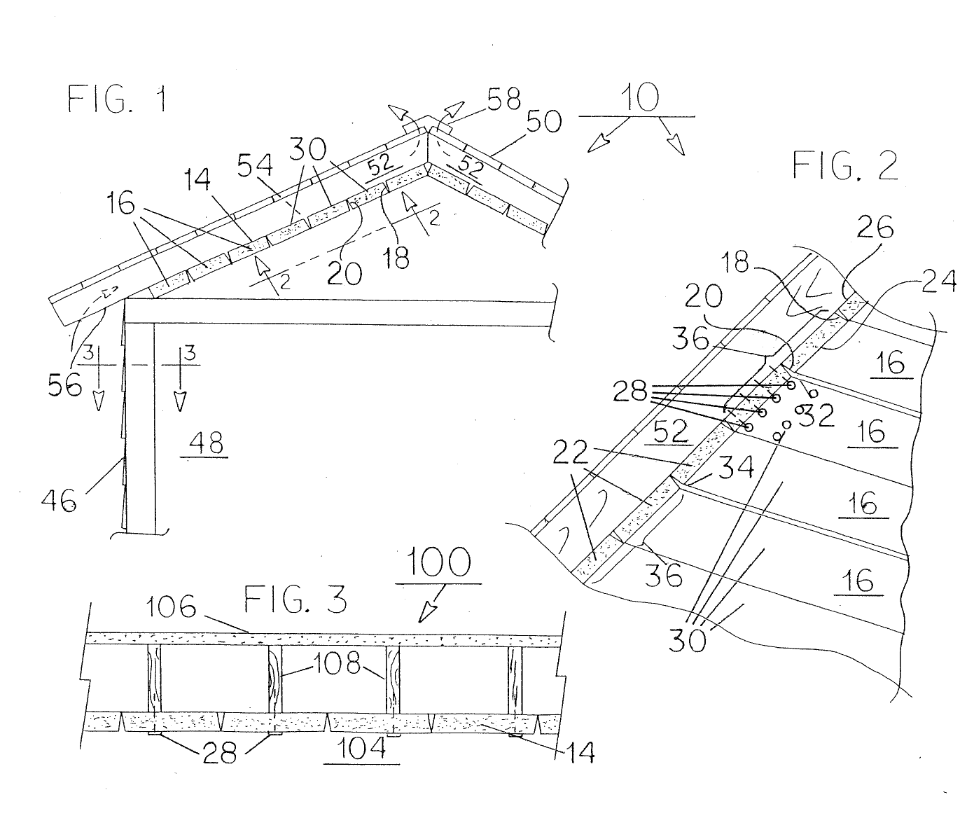

With reference now to the drawings, and in particular to FIG. 1 thereof, the preferred embodiment of the new and improved insulating system embodying the principles and concepts of the present invention and generally designated by the reference numeral 10 will be described.

The present invention, the insulating system 10 is comprised of a plurality of components. Such components in their broadest context include a plurality of thermally insulating panels, a plurality of reflective sheets, and an air space. Such components are individually configured and correlated with respect to each other so as to attain the desired objective.

First provided is an insulating assembly 14. The insulating assembly includes a plurality of generally rigid rectilinear panels 16. Each panel has a top edge 18. Each panel has a parallel bottom edge 20. The top and bottom edges are separated by a height of from 36 to 60 inches. Each panel has parallel side edges 22. The side edges are separated by a width of from 36 to 60 inches. Each panel has an interior face 24. Each panel has an exterior face 26. The interior and exterior faces are separated by a thickness of from 1 to 3 inches. Each panel is fabricated of thermally insulating foam.

The insulating assembly also includes a plurality of flexible reflective sheets 30. Each sheet has a top edge 32. Each sheet also has a parallel bottom edge 34. The top and bottom edges are separated by a height. The height is essentially equal to the height of each panel. Each sheet has parallel side edges 36. The side edges are separated by a width of essentially equal to the width of two panels. Each sheet has an intermediate extent. The intermediate extent is provided parallel with the side edges. The intermediate extent is equally spaced from the side edges. Each sheet has an interior face 38. Each sheet has an exterior face 40. The sheets are separated by a panel thickness of from 0.25 to 3.00 inches. Each sheet is fabricated of aluminized mylar.

An adhesive 42 is provided next. The adhesive couples the interior faces of the sheets to the interior and exterior faces of the panels. The panels are aligned side edge to side edge. The adhesive couples the panels in pairs. Each intermediate extent overlies each side edge of adjacent sheets. The insulating assembly is adapted to be configured in a stacked orientation during storage and transportation. The insulating assembly is adapted to be configured in a planar orientation during operation and use.

Provided last is a building 46. The building has a living zone 48. The living zone is provided below. The building has a roof 50. The roof is provided above. The building has rafters 52. The rafters support the roof. An insulating assembly is attached to the rafters on the side thereof remote from the roof. In this manner a space 54 is formed between the roof and the insulating assembly. The space has a soffit 56. The soffit is provided at a lower end. The space has a roof vent 58. The roof vent is provided at an upper end.

In this manner the thermal insulation system is adapted to reduce the heating of the living zone through radiation due to reflectivity of the reflective sheets on the exterior faces of the panels when the reflective sheets are clean and when dirty due to reflectivity of the reflective sheets on the interior surfaces.

Also in this manner the thermal insulation system is adapted to reduce the heating of the living zone through conduction abatement due to the thermal insulating properties of the panels.

Further in this manner the thermal insulation system is adapted to reduce the heating of the living zone through convection due to the flow of heated air from the soffit to the roof vent.

In alternate embodiment 100 of the system, the building has a living zone 104. The living zone is provided interiorly. The living zone has an exterior wall 106. The exterior wall is provided exteriorly. The living zone has studs 108. The studs extend interiorly from the exterior wall.

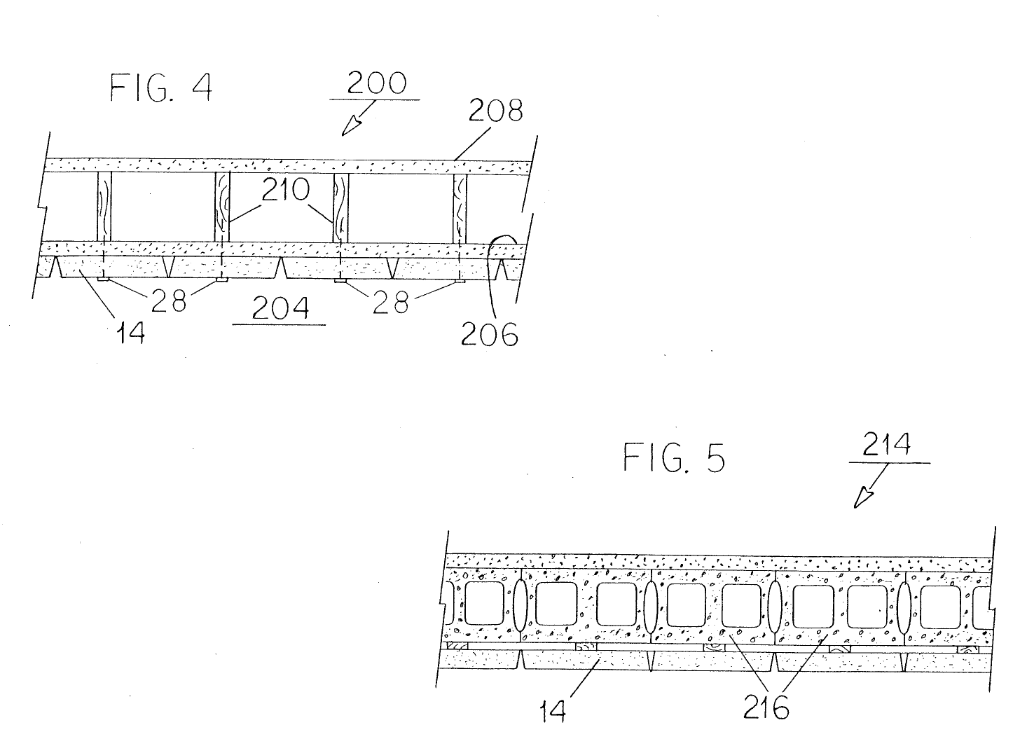

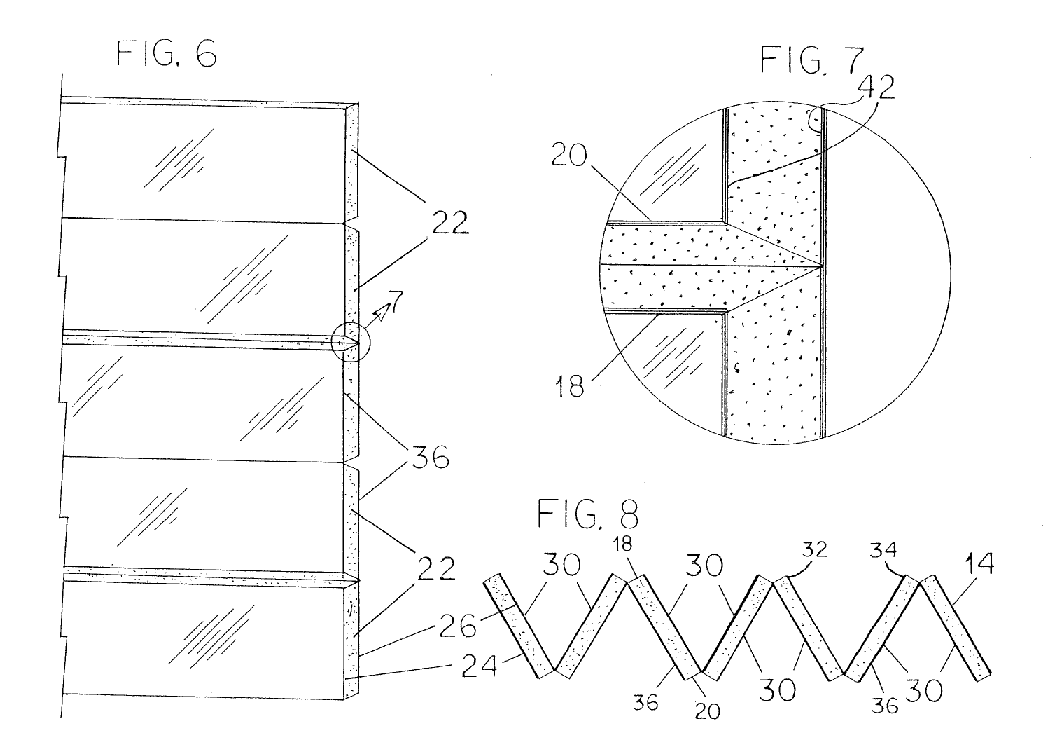

An insulating assembly 112 is provided. In this manner the insulating assembly is attached to the studs on the side thereof remote from the exterior wall. Also in this manner a space between the exterior wall and the insulating assembly. Note FIG. 4.

In another alternate embodiment 200 of the system, the building has a living zone 204. The living zone is provided interiorly. The living zone has interior and exterior walls 206, 208. The living zone has studs 210. The studs are provided between the interior and exterior walls.

In this manner the insulating assembly is attached to the interior wall on the side thereof remote from the exterior wall. In this manner a space is formed between the interior and exterior walls. Sound abatement is also facilitated. Note FIG. 4.

FIG. 5 illustrates an alternate embodiment 214 of insulation system wherein cinder blocks 216 create the space between the interior wall and the exterior wall.

As a further alternate embodiment of the invention, the embodiments of FIGS. 4 and 5 are adapted to be configured to create an air flow through the space for heat abatement through convection.

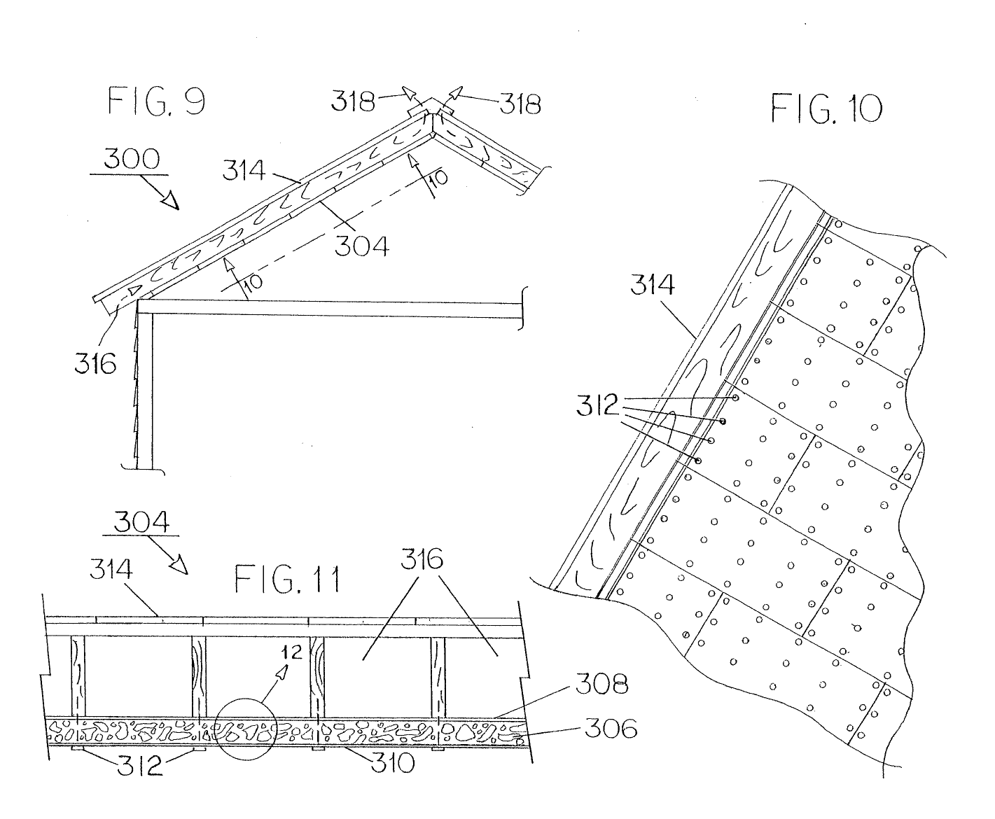

FIGS. 9-16 illustrate yet further alternate embodiments of the invention wherein the panels and the insulation assemblies are not initially coupled together. FIG. 9 shows an overall system 300 with a plurality of insulation assemblies 304. Each insulation assembly includes an insulation panel 306. Each panel has adhered thereto an interior reflective sheet 308 and an exterior reflective sheet 310. The specific materials and thicknesses of the panels and sheets are any of a wide variety as described above and as a function of the particular application. The panels and insulation assemblies are normally rectangular with a 2 by 4 foot size or a 3 by 5 foot size or any of a wide variety of other manufactured sizes or cut to fit an application as needed.

Securement of the insulation assemblies is through fasteners 312, nails or screws, for coupling to the roof 314 through intermediate studs. The studs extend from soffits below to roof vents 318 above to create an air space 316 for the natural upward flow of heated air between the insulation assemblies and the roof.

During use, the plurality of thermally insulating panels is adapted to abate the transmission of heat through conduction. In addition, the a plurality of reflective sheets coupled to the thermally insulating panels is adapted to abate the transmission of heat through radiation. Lastly, the air space in proximity to the insulating panels with means to create a flow of air through the space, whereby there is a flow of air through the air space, is adapted to abate the transmission of heat through convection.

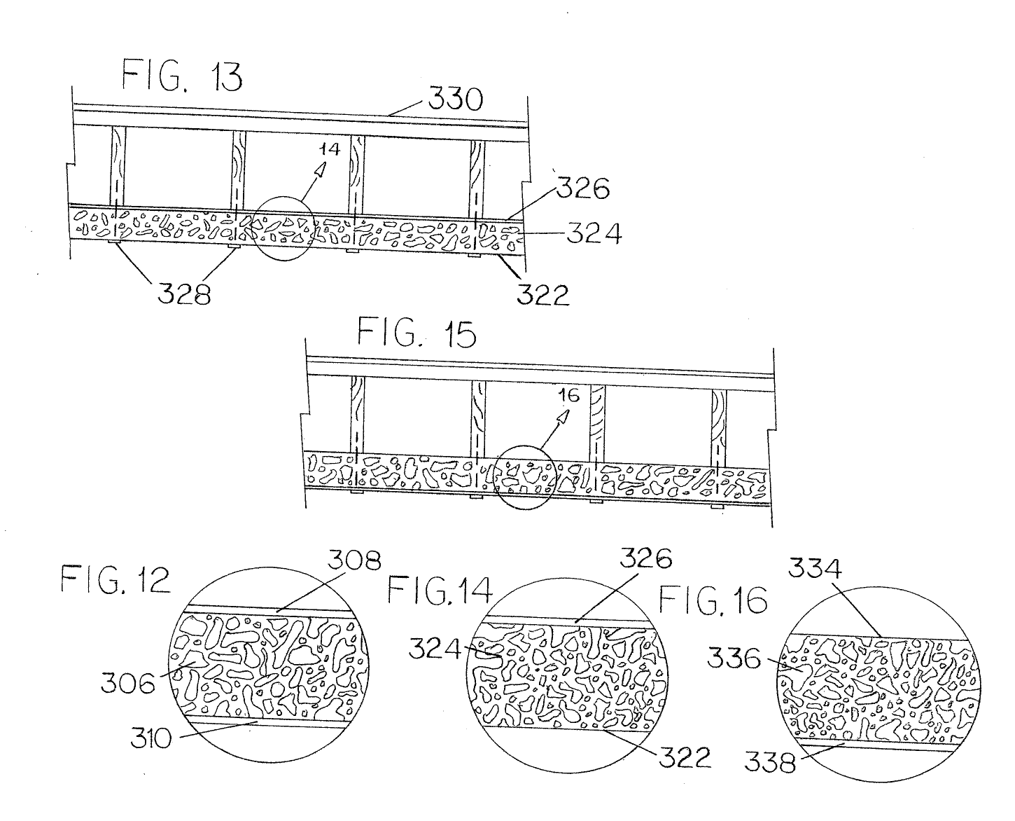

A further alternate embodiment 330 is illustrated in FIGS. 13 and 14. In such alternate embodiment, each insulation assembly 332 includes an insulation panel 324 and an interior reflective sheet 326. An interior reflective sheet is not utilized. Each insulating panel thus has a reflective sheet 326 on the interior surface only and with no reflective sheet on the exterior surface. Fasteners 328 couple the insulation assemblies to the studs which in turn couple to the roof with an air space there between as described above. Also as described above, heating is reduced while cooling is promoted through conduction abatement, increased radiation and through convection.

A next alternate embodiment 330 is illustrated in FIGS. 15 and 16. In such final alternate embodiment, each insulation assembly 334 includes an insulation panel 336 and an exterior reflective sheet 338. An interior reflective sheet is not utilized. Each insulating panel thus has a reflective sheet 338 on the exterior surface only and with no reflective sheet on the interior surface. Fasteners couple the insulation assemblies to the studs which in turn couple to the roof with an air space there between as described above. Also as described above, heating is reduced while cooling is promoted through conduction abatement, increased radiation and through convection.

Turning now to FIG. 17, there is shown a system 400. In such system each panel has parallel slits 404, 406 extending upwardly from the exterior face 408. Each slit terminates adjacent to the interior face 410. In this manner the reflective sheet 412 on the interior face functions as a hinge and allows edge sections 414, 416 to be folded upwardly at 90 degree angles and frictionally hold each panel between rafters 418.

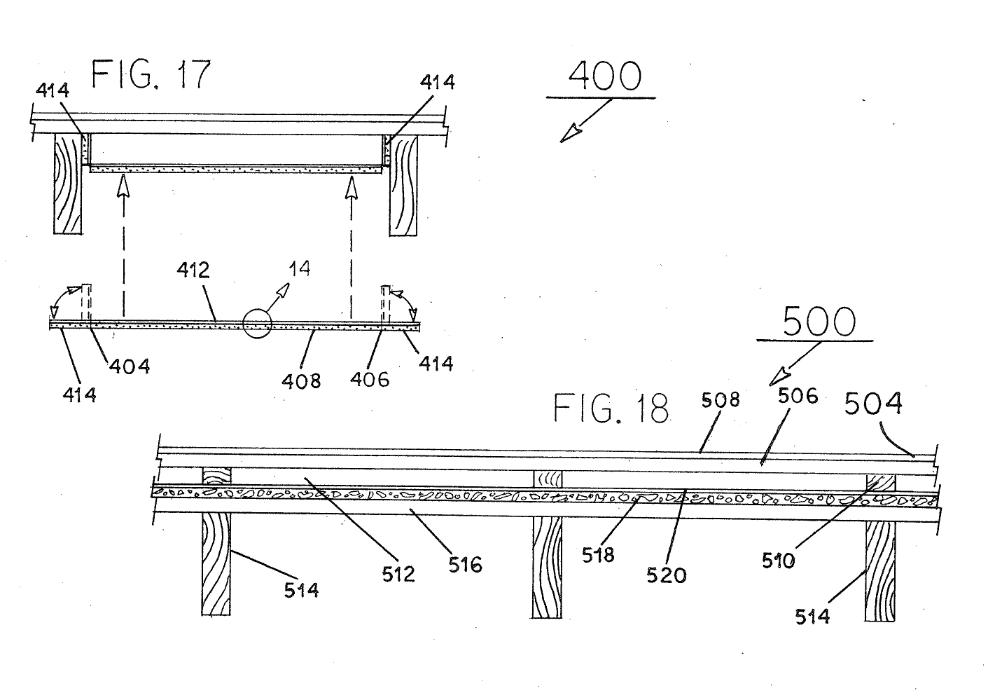

FIG. 18 illustrated a system 500 wherein each new roof 504 includes a new deck 506 and shingles 508. Beneath the new roof is a foam panel 518 below and a reflective surface 520 above. The foan panel is positioned upon the old roof 516. Firing strips 510 are located between the reflective sheet and the new deck to create air space 512. The new roof, foam panel and reflective surface are secured in position by trusses 514. 514.

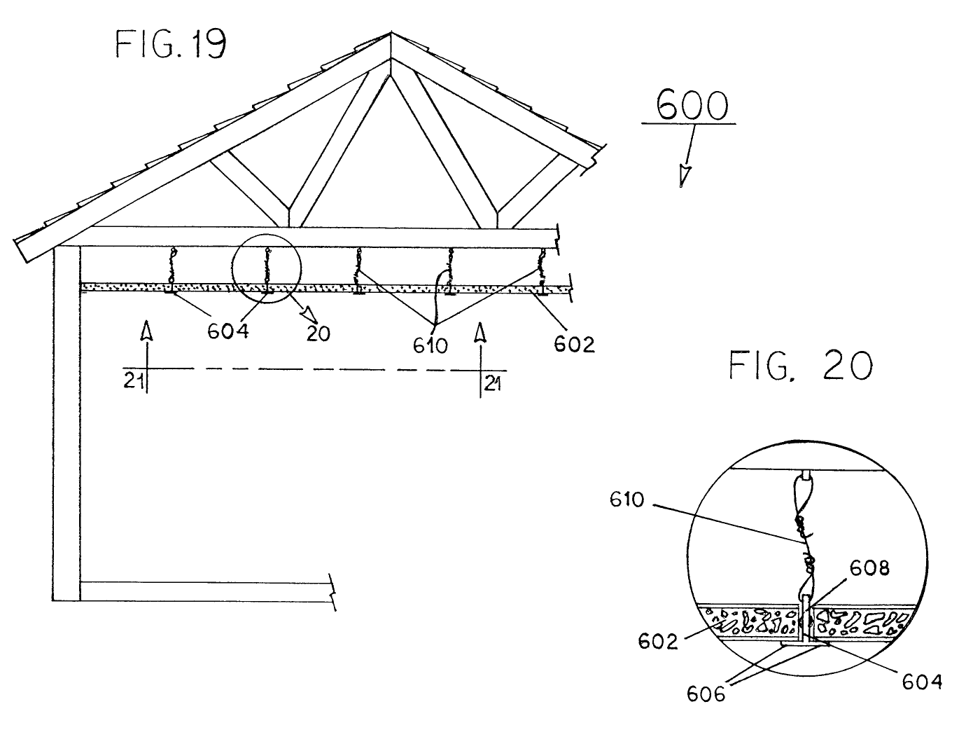

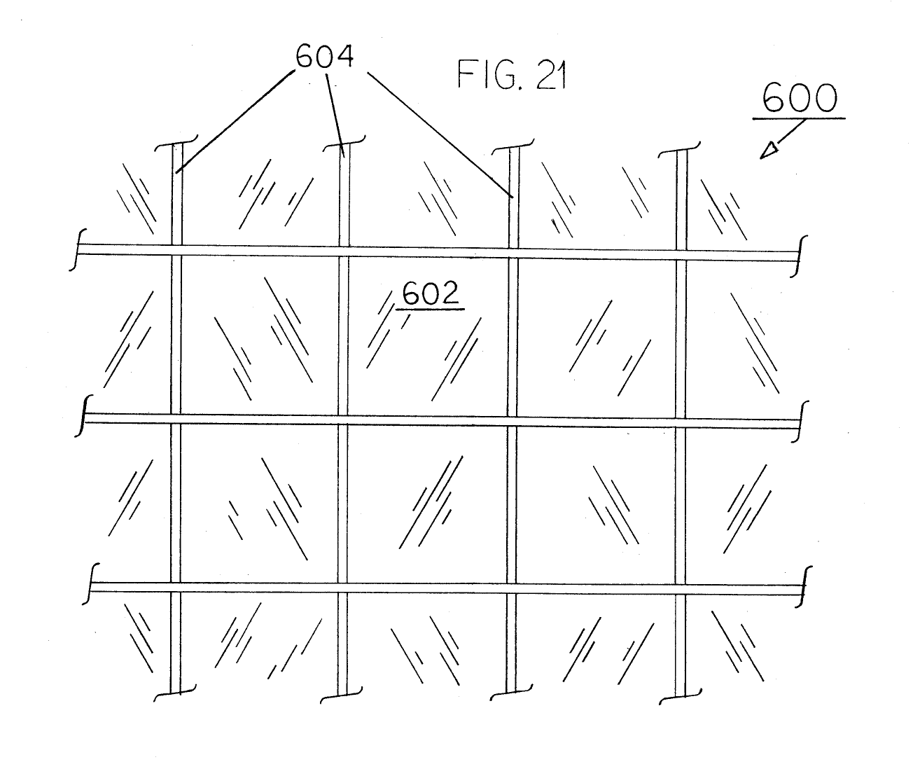

The next system 600 includes adjacent panels having a linear support 604. The linear support is in an inverted T-shaped configuration. Each support has laterally extending sections 506 supporting adjacent panels by their exterior faces 608. Each support has a central section positionable between adjacent panels. Wires 610 couple the central sections to rafters 612 there above. Note FIGS. 19, 20 and 21.

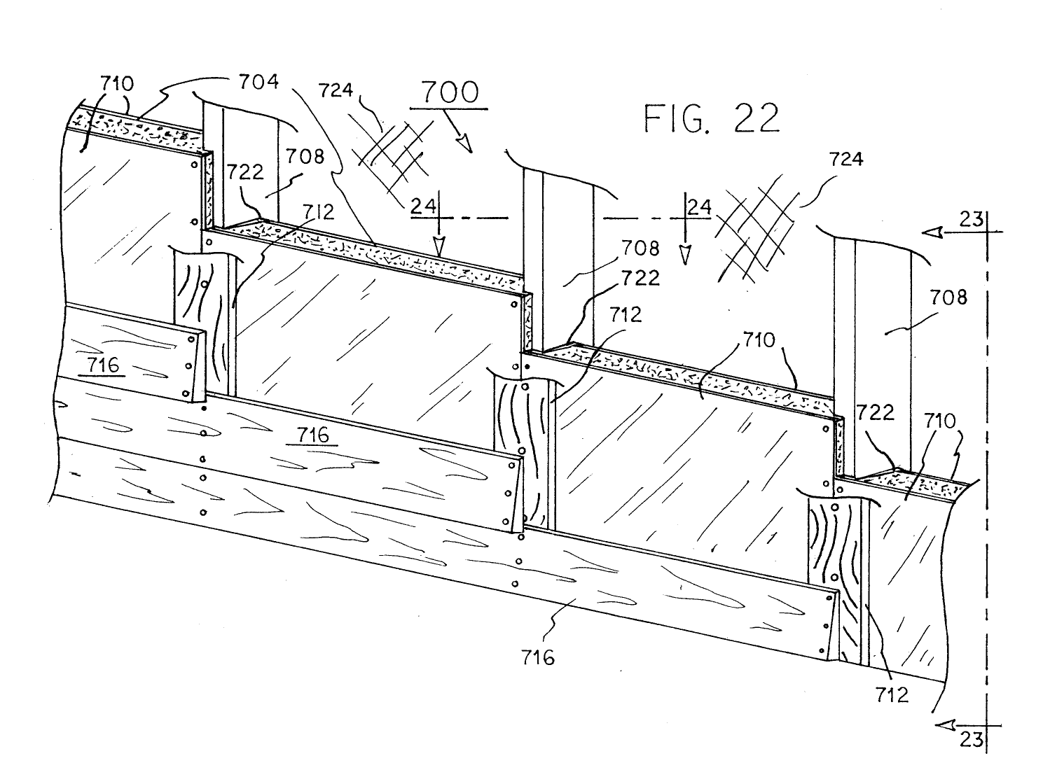

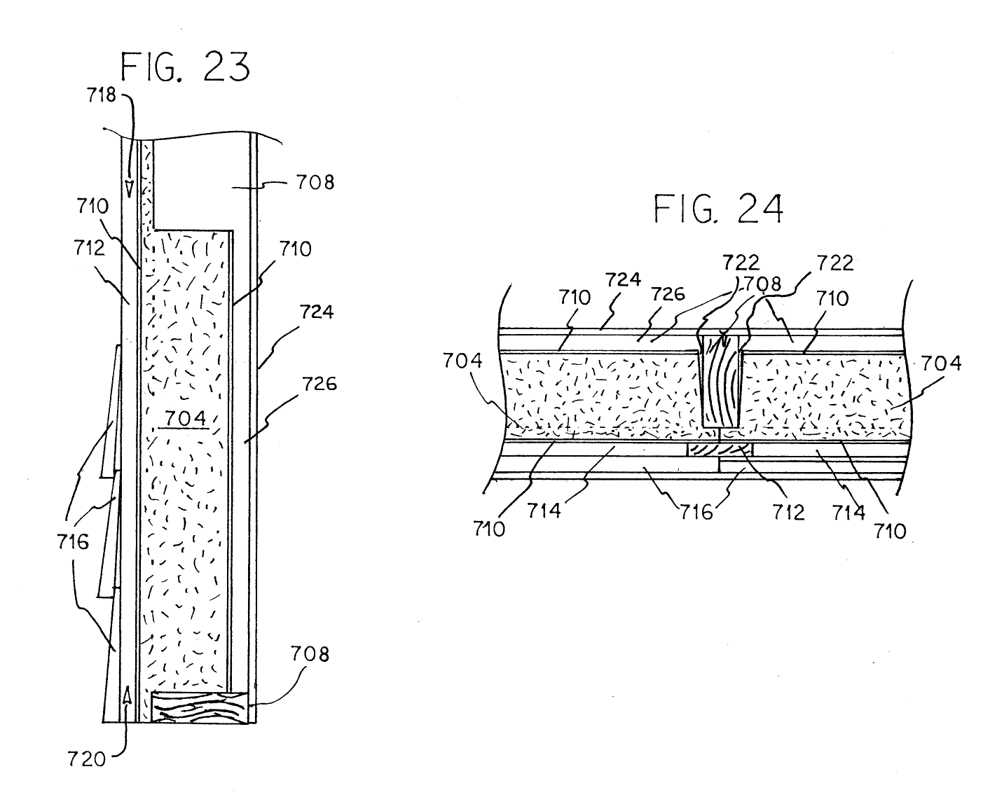

FIGS. 22, 23 and 24 illustrate the final alternate embodiment of the invention featuring a system 700 for wall applications. In such application, the thermally insulating panels 704 are vertically insulated adjacent to a wall of a building. Framing boards 708 support the thermally insulating panels. The reflective sheets 710 are secured to at least one surface of the thermally insulating panels, both surfaces in the disclosed preferred embodiment. Also included are vertically oriented nailer boards 712 laterally spaced from each other to form air spaces 714 between the insulating panels and building siding 716. The side edges of each panel are preferably trimmed to form a shallow angle 722 to facilitate positioning the panels between supporting framing boards. The air spaces have upper openings 718 above the air spaces and lower openings 720 below the spaces whereby heat generated in the air spaces will cause an air flow upwardly through the air spaces. An inner finished wall 724 creates an air space 726 between the inner finished wall and the insulating panel 704. The system of this embodiment provides insulation from heat conduction, convection and radiation. The system also constitutes a rain shield as well as an insulation and radiation barrier.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A thermal insulation system comprising:
a plurality of thermally insulating panels adapted to abate the transmission of heat through conduction;
a plurality of reflective sheets coupled to the thermally insulating panels adapted to abate the transmission of heat through radiation; and
an air space in proximity to the insulating panels with means to create a flow of air through the space whereby the flow of air through the air space is adapted to abate the transmission of heat through convection.

2. The system as set forth in claim 1 wherein the insulating panels (306) have in interior surface and an exterior surface, and wherein the insulating panels have a sheet of reflective material (308) on the interior surface and a sheet of reflective material (310) on the exterior surface.

3. The system as set forth in claim 1 wherein the insulating panels (324) have an interior surface and an exterior surface, and wherein the each insulating panel has a reflective sheet (326) on the interior surface only and with no reflective sheet on the exterior surface.

4. The system as set forth in claim 1 wherein the insulating panels (336) have an interior surface and an exterior surface, and wherein each insulating panel has a reflective sheet (338) on the exterior surface only and with no reflective sheet on the interior surface.

5. A thermal insulation system comprising:
an insulating assembly formed of a plurality of rectilinear panels having upper and lower and side edges with interior and exterior faces;
a plurality of reflective sheets having upper and lower and side edges with interior and exterior faces;
an adhesive coupling the interior faces of the sheets to the interior and exterior faces of the panels;
whereby the thermal insulation system is adapted to reduce the heating of a building through radiation and conduction abatement.

6. The system as set forth in claim 5 wherein:
the distance between the side edges of the sheets is twice the distance between the side edges of the panels;
each sheet has an intermediate extent parallel with and equally spaced from the side edges;
the adhesive coupling the interior faces of the sheets to the interior and exterior faces of the panels joins the panels side edge to side edge;
the adhesive couples the panels in pairs with each intermediate extent overlying each side edge of adjacent sheets; and
the insulating assembly is adapted to be configured with the panels in a stacked orientation for storage and transportation and with the panels in a planar orientation for operation and use.

7. The system as set forth in claim 5 and further including:
a building having a living zone below and a roof above and rafters supporting the roof; and wherein
the insulating assembly is attached to the rafters on the side thereof remote from the roof to form a space between the roof and the insulating assembly; and
the space has a soffit below at a lower end of the space and a roof vent above at an upper end of the space to facilitate an air flow with a reduction of heating in the living zone through convection.

8. The system (100) as set forth in claim 5 and further including:
a building having a living zone (104) interiorly, an exterior wall (106) exteriorly, studs (108) extending interiorly from the exterior wall; and
wherein the insulating assembly (112) is attached to the studs on the side thereof remote from the exterior wall to form a space between the exterior wall and the insulating assembly.

9. The system (200) as set forth in claim 5 and further including:
a building having a living zone (204) interiorly, interior and exterior walls (206), (208) with studs (210) between the interior and exterior walls; and
wherein the insulating assembly is attached to the interior wall on the side thereof remote from the exterior wall to form a space between the interior and exterior walls.

10. The system as set forth in claim 5 and further including:
a building having a side wall formed of cinder blocks with interior and exterior surfaces with vertically extending spaces between the interior and exterior surfaces.

11. The system as set forth in claim 5 wherein the panels are fabricated of foam.

12. The system as set forth in claim 5 wherein the sheets are fabricated of aluminized mylar.

13. The system (400) as set forth in claim 5 wherein each panel has parallel slits (404), (406) extending upwardly from the exterior face (408) and terminating adjacent to the interior face (410) whereby the reflective sheet (412) on the interior face functions as a hinge and allows edge sections (414), (416) to be folded upwardly at 90 degree angles and frictionally hold each panel between rafters (418).

14. The system (500) as set forth in claim 5 wherein each panel assembly includes a panel (518) below and a reflective sheet (520) above, firing strips (510) secure each panel to an existing roof (516) with an air space between the old roof and the panel assembly.

15. The system (600) as set forth in claim 5 wherein adjacent panels have a linear support (604) in an inverted T-shaped configuration, each support having laterally extending sections (606) supporting adjacent panels by their exterior faces (608), each support having a central section positionable between adjacent panels and a wire (610) coupling the central sections to rafters (612).

16. The system (700) as set forth in claim 1 wherein the thermally insulating panels (704) are vertically insulated adjacent to a wall of a building and the reflective sheets (708) are secured to at least one surface of the thermally insulating panels and also including vertically oriented nailer boards (710) laterally spaced from each other to form air spaces (714) between the insulating panels and building siding (716), a shallow angle (722) formed in the side edges to facilitate positioning the panels between supporting framing boards, the air spaces having upper openings (714) above the air spaces and lowe8 openings (720) below the spaces whereby heat generated in the air spaces will cause an air flow upwardly through the air spaces.

17. A thermal insulation system (10) adapted to reduce the heating of a building through radiation and conduction abatement, such abatement being done is a safe, convenient and economical manner, the system comprising, in combination:
an insulating assembly (14) formed of a plurality of generally rigid rectilinear panels (16), each panel having a top edge (18) and a parallel bottom edge (20) separated by a height of from 36 to 60 inches, each panel having parallel side edges (22) separated by a width of from 36 to 60 inches, each panel having an interior face (24) and an exterior face (26) separated by a thickness of from 1 to 3 inches, each panel being fabricated of thermally insulating foam;
the insulating assembly also formed of a plurality of flexible reflective sheets (30), each sheet having a top edge (32) and a parallel bottom edge (34) separated by a height essentially equal to the height of each panel, each sheet having parallel side edges (36) separated by a width of essentially equal to the width of two panels, each sheet having an intermediate extent parallel with the side edges and equally spaced from the side edges, each sheet having an interior face (38) and an exterior face (40), the sheets are separated by a panel thickness of from 0.25 to 3.00 inches, each sheet being fabricated of aluminized mylar;
an adhesive (42) coupling the interior faces of the sheets to the interior and exterior faces of the panels with the panels being aligned side edge to side edge, the adhesive coupling the panels in pairs with each intermediate extent overlying each side edge of adjacent sheets, the insulating assembly adapted to be configured in a stacked orientation during storage and transportation, the insulating assembly adapted to be configured in a planar orientation during operation and use; and
a building (46) having living zone (48) below and a roof (50) above and rafters (52) supporting the roof, an insulating assembly attached to the rafters on the side thereof remote from the roof to form a space (54) between the roof and the insulating assembly, the space having a soffit (56) at a lower end and a roof vent (58) at an upper end;
whereby the thermal insulation system is adapted to reduce the heating of the living zone through radiation due to reflectivity of the reflective sheets on the exterior faces of the panels when the reflective sheets are clean and when dirty due to reflectivity of the reflective sheets on the interior surfaces; and
whereby the thermal insulation system is adapted to reduce the heating of the living zone through conduction abatement due to the thermal insulating properties of the panels; and
whereby the thermal insulation system is adapted to reduce the heating of the living zone through convection due to the flow of heated air from the soffit to the roof vent.
